(19) United States
(12) Patent Application Publication
(10) Pub. No.: US 2012/0085453 A1
(43) Pub. Date: Apr. 12, 2012

(54) END PLUG

(76) Inventor: Francis Desmond Lourigan, Queensland (AU)

(21) Appl. No.: 13/377,294

(22) PCT Filed: Jun. 17, 2010
(86) PCT No.: PCT/AU10/00749

§ 371 Date: Dec. 9, 2011

(30) Foreign Application Priority Data
Jun. 17, 2009 (AU) 2009902779

(51) Int. Cl. F16L 55/10

(52) U.S. Cl. 138/89

(57) ABSTRACT

An end plug for use with a pipe compression fitting, the end plug having a central compression collar; and a stem connected to and extended outwardly from each end of the central compression collar.

### FIELD OF THE INVENTION

This invention relates to a plug. In particular, the invention relates to a plug for use in sealing a pipe fitting and therefore will be described in this context. However, it should be appreciated that the invention may be used for sealing other types of pipes.

### BACKGROUND OF THE INVENTION

Water pipes are located within virtually every modern building. It is often necessary to seal these pipes when building or renovating. In new building work, copper pipes can often be sealed by brazing over the ends. However, this method is not common once a pipe becomes active. This is due to water located within the pipe causing substantially longer brazing times compared to pipe that has no water located within the pipe. Furthermore, the brazed joint is more susceptible to failure. Further, once the pipe has been sealed by brazing, it is difficult to unseal the pipe at a later date, especially when access is difficult. Unsealing the pipe in this instance is usually accomplished by cutting off the brazed joint which allows for reconnection.

A common method of joining one pipe to an adjacent pipe is through the use of a brass compression fitting. A compression fitting typically includes a hollow compression body, two compression nuts and two nylon olives. In order to install a compression fitting, a compression nut containing a nylon olive is slid over the end of a pipe. The compression body is also slid over the pipe. The compression nut is then screwed onto the compression body compressing the nylon olive against the pipe to provide a seal. This is then repeated with the adjacent pipe to join the pipes together.

In order to seal a pipe, a compression body is used. The compression body is attached to an end of the pipe using a compression nut and nylon olive, as described previously. At the other end of the compression body, a stop cap is used instead of a further compression nut. A brass stop cap is similar to a compression nut except that the end is sealed. Accordingly, once the stop cap is screwed onto the compression body, the pipe is sealed.

A modified brass stop cap has also been produced which is able to be screwed onto a compression nut. In use, a compression nut containing a nylon olive is slid over the end of a pipe. The stop cap is then screwed onto the compression nut compressing the nylon olive against the pipe to provide a seal.

There are several issues with the use of stop caps. The first issue is that stop caps are expensive to produce and purchase as they are made of brass. Further, they are heavy and add considerable weight to the already large number of components that plumbers need to carry. The second issue is that stop caps require the use of thread tape in order to create an adequate seal. The application of thread tape also increases the time and expense required to produce a seal.

### OBJECT OF THE INVENTION

It is an object of the invention to overcome and/or alleviate one or more of the above problems or provide the consumer with a useful and/or commercial choice.

### SUMMARY OF THE INVENTION

In one form, although not necessarily the only or broadest form, the invention resides in an end plug for use with a pipe compression fitting, the end plug comprising:

a central compression collar; and

a stem connected to and extended outwardly from each end of the central compression collar.

One or more of the stems may be at least partially solid to form a water barrier. Alternatively, the central compression collar may be partially solid to form a water barrier. Preferably, the stems are hollow with at least part of the compression collar being solid to form a water barrier.

The central collar may be integrally formed with one or more of the stems. Normally the entire end plug is integrally formed. The end plug is normally made of a resilient material, such as nylon. However, other suitable materials may be used, such as copper, brass and suitable plastics.

At least one outer side wall of the compression collar is tapered. Preferably, there are two outer side walls of the compression collar that are tapered. The tapered outer sides walls may terminate adjacent one another. Alternatively, the tapered sides may terminate at a flat outer side wall.

Normally, an outer side wall of at least one stem is tapered. Preferably, the outer side walls of both stems are tapered. The taper may be at ratio greater than 1:10. Preferably the taper is at a ratio greater than 1:20. More preferably, the taper is at a ratio greater than 1:40.

In another form, the invention resides in an apparatus for sealing a pipe, the apparatus including:

a pipe fitting;

an end plug having a central compression collar and two stems connected to and extended outwardly from opposite ends of the central compression collar, one of the stems located within the pipe fitting; and

a compression nut fitted to the pipe fitting such that other of the stems of the end plug is located through the compression nut.

In yet another form, the invention resides in a method for sealing a pipe fitting, the method including the steps of:

locating an end plug having a central compression collar and two stems connected to and extending outwardly from opposite ends of the central compression collar into the pipe fitting; and

locating a compression nut onto the pipe fitting such that a stem of the end plug is located through the compression nut.

### BRIEF DESCRIPTION OF THE DRAWINGS

Embodiments of the invention will now be described with reference to the accompanying drawings in which:

FIG. 1 is a oblique view of an end plug according to a first embodiment of the invention;

FIG. 2 is a sectional view of the end plug of FIG. 1 according to the first embodiment of the invention;

FIG. 3 is a sectional view of the end plug of FIG. 1 according to the second embodiment of the invention;

FIG. 4 is a sectional view of the end plug of FIG. 1 according to the third embodiment of the invention;

FIG. 5 is a sectional view of the end plug of FIG. 1 according to the fourth embodiment of the invention; and

FIG. 6 is a sectional view of the end plug of FIG. 1 located within a pipe fitting.

### DETAILED DESCRIPTION OF THE PREFERRED EMBODIMENT

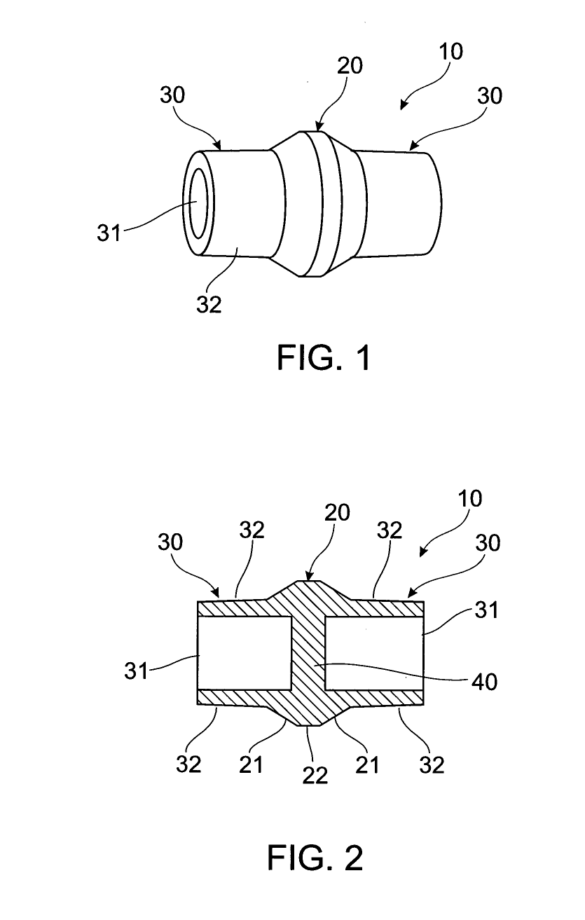

FIG. 1 shows an end plug 10 able to be used with pipe fitting in order to seal the pipe fitting. The end pipe 10 is integrally formed and constructed of nylon.

The end plug 10 includes a central compression collar 20 and two stems 30. The two stems 30 are connected to and extend outwardly from opposite ends of the central compression collar 20. Each of the two stems 30 are substantially cylindrical in shape and are substantially hollow. That is, a hole 31 extends into the ends of the two stems 30. The two stems 30 are of equal length and have an outer side wall 32. The outer side wall 32 of each of the stems is tapered at a ratio of 1:40.

The central compression collar 20 is integrally formed with the stems 30. The compression collar 20 has two tapered side walls 21 which are interconnected by a flat outer side wall 22. The compression collar 20 is partially solid in order to form a water barrier 40 which forms part of the compression collar 20.

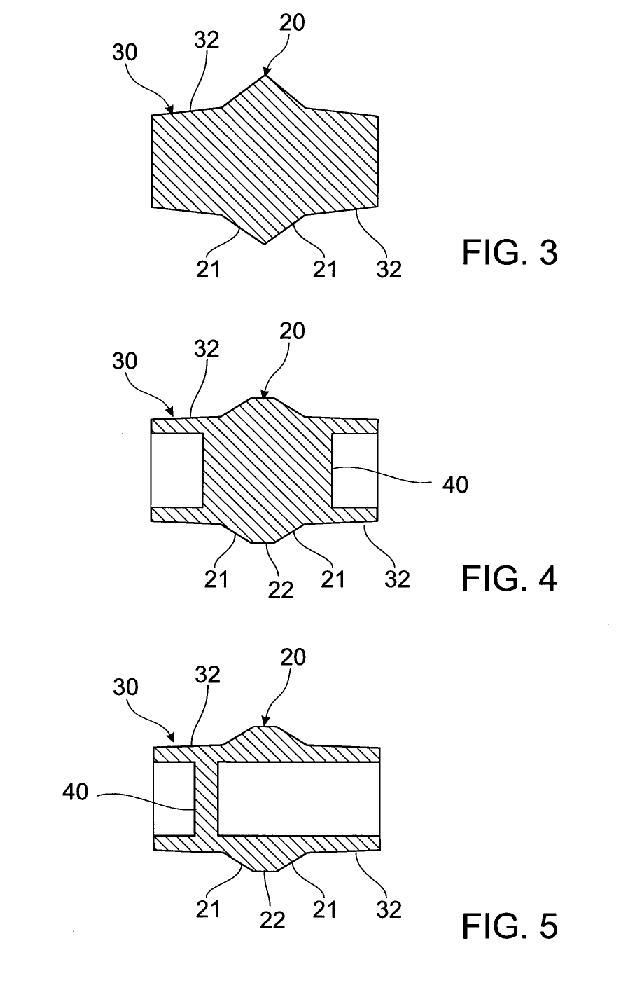

It should be appreciated that the two tapered side walls 21 of the compression collar may terminate adjacent each other as shown in FIG. 3.

It also should be appreciated that although the water barrier 40 forms part of the compression collar 20 in the embodiment described, the water barrier 40 forms the entire stem 30 and compression collar 20, as shown in FIG. 3. Alternatively, the water barrier 40 may be made thicker so that it forms part of the compression collar 20, as shown in FIG. 4. Still alternatively, the water barrier may be located into one or more of the stems 30, as shown in FIG. 5.

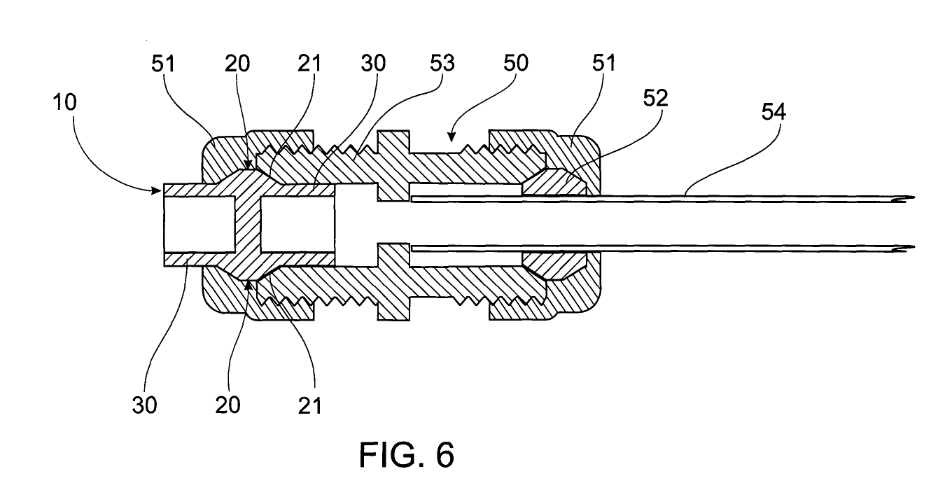

In use, the end plug 10 is used with a pipe fitting, such as a compression fitting 50, as shown in FIG. 6. The compression fitting 50 includes two compression nuts 51, a nylon olive 52, compression body 53 and an end plug 10. The compression fitting 50 is attached to a pipe 54 in a standard manner. That is, a compression nut 51 containing a nylon olive 52 is slid over the end of the pipe 54. The compression body 53 is then also slid over the pipe 54. A threaded portion of the compression nut 51 is then screwed onto a thread portion compression body 53 to compress the nylon olive 52 against the pipe 54 to provide a seal.

In order to seal the compression fitting 50, a stem 30 of the end plug 10 is located within the compression body 53. A compression nut 51 is then located over the other stem 30 of the end plug 10 and a threaded portion of the compression nut 51 screwed onto a threaded portion of the compression body 53. This causes a tapered side wall 21 of the compression collar 20 to engage with the compression body 53 sealing the compression fitting 50.

The end plug 10 provides a number of advantages. Firstly, the end plug 10 removes the need for the use of threaded sealed tape. Secondly, there is significantly less time and effort to install the end plug 10 when compared to a stop cap. Thirdly, the compression nut 51 requires minimal rotational force in order for the end plug 10 to achieve a seal. Fourthly, the end plug 10 can also be reused. Fifthly, as the end plug 10 is symmetrical, little thought is needed when positioning the end plug 10 in the pipe fitting. Sixthly, the stems 30 also allow for easy removal from both the compression body 53 and the compression nut 51. Lastly, as the end plug 10 is made from nylon, it is relatively light and is easily carried.

It should be appreciated that various other changes and modifications may be made to the embodiment described without departing from the spirit or scope of the invention.

1-15. (canceled)

16. An end plug for use with a pipe compression fitting, said end plug comprising:
a central compression collar; and
a stem connected to and extended outwardly from each end of said central compression collar.

17. The end plug of claim 16, wherein at least one of said stems is at least partially solid to form a water barrier.

18. The end plug of claim 16, wherein said central compression collar is partially solid to form a water barrier.

19. The end plug of claim 16, wherein said stems are hollow with at least part of said compression collar being solid to form a water barrier.

20. The end plug of claim 16, wherein said central collar is integrally formed with one or more of said stems.

21. The end plug of claim 16, wherein said end plug is made of a material selected from the group consisting of a resilient material, and nylon.

22. The end plug of claim 16, wherein said compression collar further comprising at least one tapered outer side wall.

23. The end plug of claim 16, wherein said compression collar further comprising at least two tapered outer side walls.

24. The end plug of claim 22, wherein said tapered outer side walls terminate adjacent one another.

25. The end plug of claim 22, wherein said tapered outer side terminate at a flat outer side wall.

26. The end plug of claim 22, wherein at least one of said stems has a tapered outer side wall.

27. The end plug of claim 22, wherein said stems each having a tapered outer side wall.

28. The end plug of claim 22, wherein said stems each being substantially cylindrical in shape with a hole defined therein.

29. An end plug system for sealing a pipe, said end plug system comprising:
a pipe fitting;
at least one end plug comprising:
a central compression collar; and
two stems connected to and extended outwardly from opposite ends of said central compression collar, one of said stems being located within said pipe fitting; and
at least one compression nut fitted to said pipe fitting such that other of said stems of said end plug is located through said compression nut.

30. The end plug system of claim 30, wherein said end plug further comprising a water barrier located in one of said central compression collar, and at least one said stems.

31. The end plug system of claim 30, wherein said compression collar further comprising at least two tapered outer side walls.

32. The end plug system of claim 32, wherein said tapered outer side walls terminate at one of adjacent one another, and a flat outer side wall located between said outer side walls.

33. The end plug system of claim 32, wherein at least one of said tapered outer side walls of said compression collar is adjacent said pitting fitting, and other of said tapered outer side walls of said compression collar is adjacent said compression nut.

34. The end plug system of claim 32, wherein said stems each having a tapered outer side wall.

35. A method of using an end plug for sealing a pipe fitting, said method comprising the steps of:
locating an end plug having a central compression collar and two stems connected to and extending outwardly from opposite ends of said central compression collar into said pipe fitting; and
locating a compression nut onto said pipe fitting such that at least one of said stems of said end plug is located through said compression nut.
